(19) United States
(12) Patent Application Publication
(10) Pub. No.: US 2015/0002474 A1
(43) Pub. Date: Jan. 1, 2015

(54) HANDHELD ELECTRONIC DEVICE

(71) Applicant: PixArt Imaging Inc., Hsin-Chu City (TW)

(72) Inventors: Yen-Min Chang, Hsin-Chu City (TW); Hui-Hsuan Chen, Hsin-Chu City (TW)

(73) Assignee: PixArt Imaging Inc., Hsin-Chu City (TW)

(21) Appl. No.: 14/184,714

(22) Filed: Feb. 20, 2014

(30) Foreign Application Priority Data
Jul. 1, 2013 (TW) 102123471

(51) Int. Cl. G06F 3/042; G06F 1/16

(52) U.S. Cl. CPC G06F 3/042; G06F 1/1694
USPC 345/175

(57) ABSTRACT

A handheld electronic device with touch control function is disclosed in the present invention. The handheld electronic device includes a housing, at least one optical detecting module and a control unit. The housing includes a display surface and a back surface opposite to each other. The housing further includes a top surface, a bottom surface and two lateral surfaces, respectively located between the display surface and the back surface. The optical detecting module is disposed on the lateral surface of the housing for detecting a movement of a touch medium. The control unit is electrically connected to the optical detecting module. The control unit outputs a control signal according to the movement of the touch medium.

### BACKGROUND OF THE INVENTION

1. Field of the Invention

The present invention relates to a handheld electronic device, and more particularly, to a handheld electronic device can be hold to execute touch control operation by one-hand.

2. Description of the Prior Art

A conventional portable communication device utilizes the keyswitch or the touch pad to input control command. A front of the portable communication device has display panel, which can be the touch panel, and the keyswitch is usually disposed by the display panel, so the user can watch the display panel and input the control command simultaneously. It is to say, the keyswitch and the touch pad are located on the front of the portable communication device. When using the conventional portable communication device, the user utilizes one hand to take the portable communication device, and then the other hand moves to the front to click the keyswitch or the touch pad. It is inconvenient to take the conventional portable communication device and move the finger to the front for touch control operation by one-hand. Thus, the conventional portable communication device with above-mentioned drawbacks does not conform to ergonomics and consumer's common custom.

### SUMMARY OF THE INVENTION

The present invention provides a handheld electronic device can be hold to execute touch control operation by one-hand for solving above drawbacks.

According to the claimed invention, a handheld electronic device with touch control function is disclosed. The handheld electronic device includes a housing, at least one optical detecting module and a control unit. The housing includes a display surface and a back surface opposite to each other. The housing further includes a top surface, a bottom surface and two lateral surfaces, respectively located between the display surface and the back surface. The optical detecting module is disposed on the lateral surface of the housing for detecting a movement of a touch medium. The control unit is electrically connected to the optical detecting module. The control unit outputs a control signal according to the movement of the touch medium.

According to the claimed invention, the lateral surface includes an upper area and a low area. The upper area is adjacent to the top surface, and the low area is adjacent to the bottom surface. The optical detecting module is disposed on the upper area of the lateral surface. The upper area is adjacent to a sound hole formed on the housing, and the low area is adjacent to a speak hole formed on the housing.

According to the claimed invention, the optical detecting module is an array arranged by a plurality of optical finger navigation units, or the optical detecting module includes a plurality of proximity sensors.

According to the claimed invention, the handheld electronic device further includes a storage unit electrically connected to the control unit for storing a reference value. The optical detecting module detects a physiology characteristic, the control unit compares the physiology characteristic with the reference value to determine whether authority of the handheld electronic device is allowed.

The present invention disposes the optical detecting module on the lateral surface of the housing, and the user can easily input the touch command by the thumb or the forefinger when taking the handheld electronic device by one-hand. The present invention provides a convenient operating method better than conventional touch operation that the touch control is executed by moving the finger to the display surface of the handheld electronic device. The handheld electronic device of the present invention can be the portable communication device or the remote controller, such as the mobile phone or the TV controller. The handheld electronic device of the present invention not only disposes the display panel and the input module (keyswitch or touch pad) on the display surface of the housing, but also disposes the optical detecting module on the lateral surface of the housing additionally. Therefore, the present invention has advantages of multiple touch control function and conveniently one-hand operation. Comparing to the prior art, the present invention aims to provide the handheld electronic device with the side-controlling optical detecting module, which conforms to consumer's habit, for increasing market competition of the product.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 and FIG. 2 respectively are diagrams of a handheld electronic device in different views according to an embodiment of the present invention.

FIG. 3 is a partial diagram of the handheld electronic device according to the embodiment of the present invention.

FIG. 4 and FIG. 5 respectively are partial diagrams of the handheld electronic device according to the other embodiments of the present invention.

FIG. 6 and FIG. 7 respectively are diagrams of an optical detecting module according to different embodiments of the present invention.

FIG. 8 to FIG. 10 respectively are diagrams of the optical detecting module according to different embodiments of the present invention.

### DETAILED DESCRIPTION

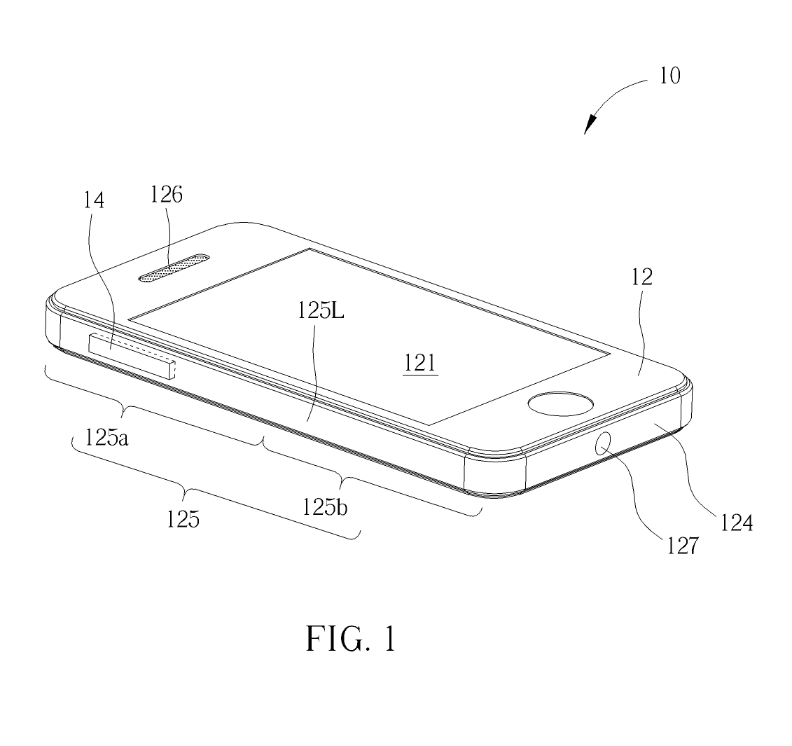

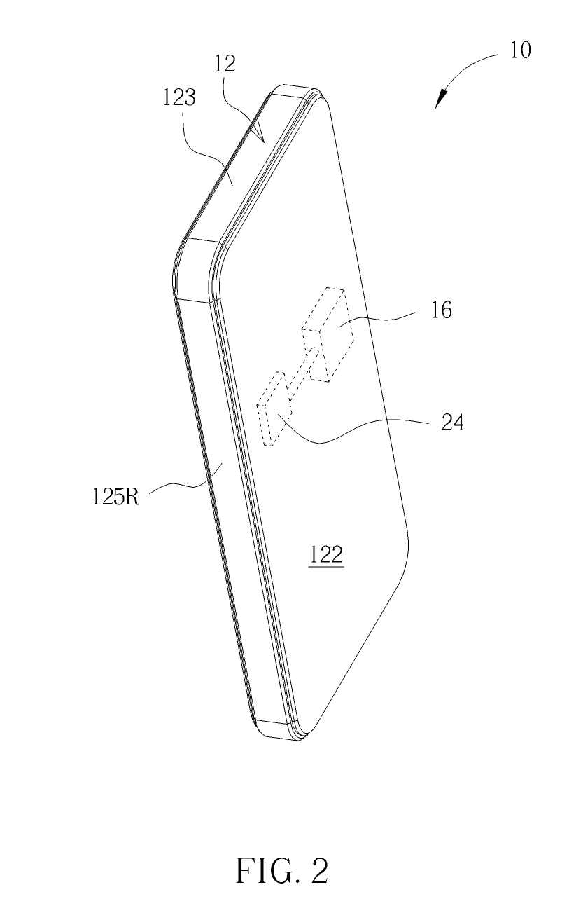

Please refer to FIG. 1 and FIG. 2. FIG. 1 and FIG. 2 respectively are diagrams of a handheld electronic device 10 in different views according to an embodiment of the present invention. The handheld electronic device 10 includes a housing 12, at least one optical detecting module 14 and a control unit 16. The housing 12 includes a display surface 121, aback surface 122, a top surface 123, a bottom surface 124 and lateral surfaces 125 (including the left lateral surface 125L and the right lateral surface 125R). The display panel (touch panel) of the handheld electronic device 10 is disposed on the display surface 121. The speaker can be disposed on the back surface 122. The display surface 121 and the back surface 122 are opposite surfaces of the housing 12. The top surface 123 and the bottom surface 124 are opposite surfaces of the housing 12. The lateral surfaces 125 are opposite to each other. The optical detecting module 14 is disposed on the lateral surface 125 (either the left lateral surface 125L or the right lateral surface 125R) of the housing 12. The control unit 16 is disposed inside the housing 12 and electrically connected to the optical detecting module 14. The optical detecting module 14 can detect a movement of a touch medium (such as user's finger), and the control unit 16 outputs a corresponding control signal according to the movement. Therefore, the present invention provides a touch control function over the lateral surface 125 of the handheld electronic device 10.

The optical detecting module 14 is a sensor utilizing an optical masking technology to obtain the movement of the touch medium. The optical detecting module 14 includes a transmitter and a receiver. The transmitter outputs an optical detecting signal, and an optical reflecting signal can be accordingly generated by the optical detecting signal reflected from the touch medium when the touch medium moves inside a detective range of the optical detecting module 14 and is projected by the optical detecting signal. The receiver receives the optical reflecting signal and transmits corresponding information to the control unit 16, and the control unit 16 can obtain the movement of the touch medium according to intensity variation of the optical reflecting signal. As shown in FIG. 1, the handheld electronic device 10 includes one optical detecting module 14 disposed on the left lateral surface 125L of the housing 12. The user can slide the thumb over the optical detecting module 14 to input a touch command when taking the handheld electronic device 10 by left hand. The present invention further can dispose the optical detecting module 14 on the right lateral surface 125R of the housing 12, or dispose two optical detecting modules 14 respectively on the opposite lateral surfaces 125 of the housing 12 for multi-finger control. Disposition of the optical detecting module depends on design demand, and a detailed description is omitted herein for simplicity.

As shown in FIG. 1, the lateral surface 125 includes an upper area 125a and a low area 125b. The upper area 125a is adjacent to the top surface 123 and a sound hole 126 formed on the housing 12. The low area 125b is adjacent to the bottom surface 124 and a speak hole 127 formed on the housing 12. The speaker is disposed inside the sound hole 126, and a microphone is disposed inside the speak hole 127. In the preferred embodiment of the present invention, the optical detecting module 14 is disposed on the upper area 125a of the lateral surface 125, and the user can conveniently utilize the thumb or the forefinger to slide over the optical detecting module 14, which conforms to ergonomics. Dimension ratio of the upper area 125a to the low area 125b is not limited to the embodiment shown in figures. Generally, dimension of the upper area 125a is equal to or smaller than dimension of the low area 125b. The dimension ratio of the upper area 125a to the low area 125b can be designed according to length, width and thickness of the housing 12.

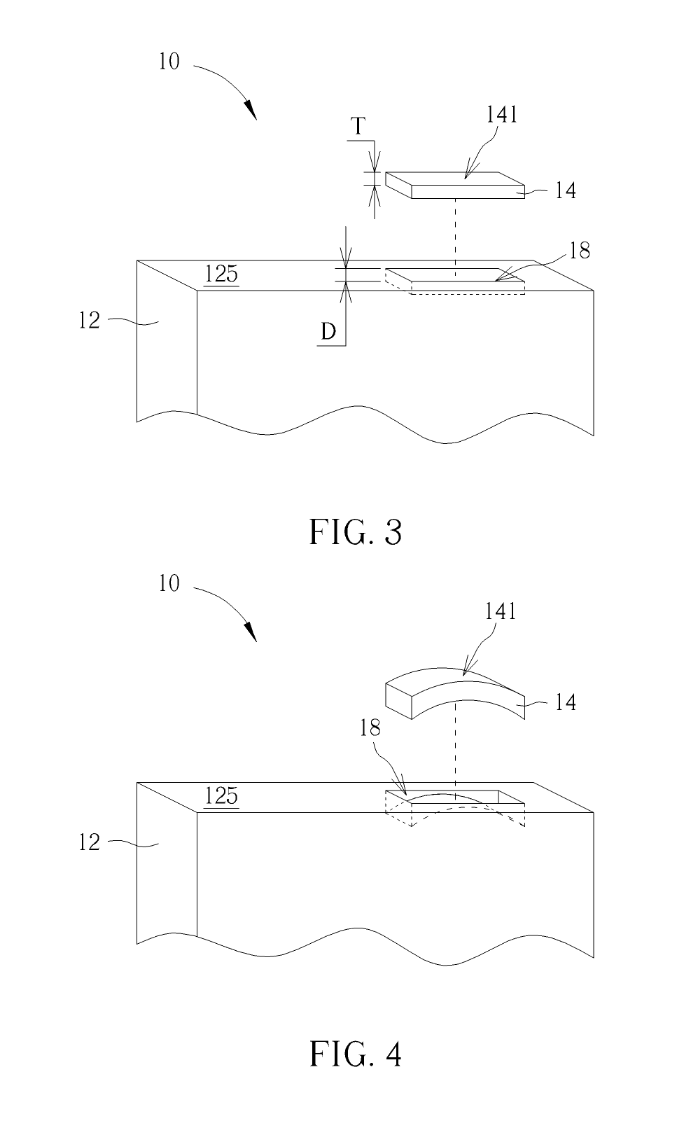

Please refer to FIG. 3. FIG. 3 is a partial diagram of the handheld electronic device 10 according to the embodiment of the present invention. The housing 12 further includes an accommodating space 18 formed on the lateral surface 125. The optical detecting module 14 can be embedded or engaged inside the accommodating space 18. A structural thickness T of the optical detecting module 14 is preferably smaller than 4 mm, and a structural depth D of the accommodating space 18 can be about 4 mm. Generally, the optical detecting module 14 can be composed of optical finger navigation units or proximity sensors, which have structural thickness T substantially as 2.7-3.3 mm. As the optical detecting module 14 is disposed inside the accommodating space 18, a detective portion 141 (top portion) of the optical detecting module 14 can connect to the lateral surface 125 in a smoothly continuous manner, and a border between the optical detecting module 14 and the housing 12 is gapless, so that the handheld electronic device 10 has preferred streamline aesthetic.

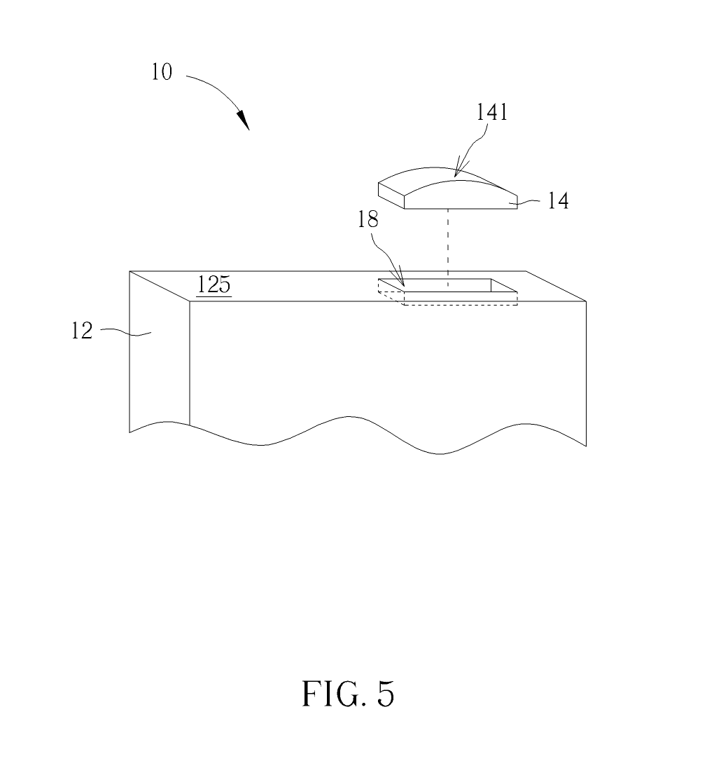

Please refer to FIG. 4 and FIG. 5. FIG. 4 and FIG. 5 respectively are partial diagrams of the handheld electronic device 10 according to the other embodiments of the present invention. As shown in FIG. 4, a base of the accommodating space 18 can be a curved structure, and the optical detecting module 14 can be a rotatable thin-typed soft structure. As the optical detecting module 14 is disposed inside the accommodating space 18, the optical detecting module 14 is bent by the curved structure, and the detective portion 141 protrudes from the lateral surface 125. As shown in FIG. 5, a base of the optical detecting module 14 can be a plane structure, and the detective portion 141 can be the curved structure. As the optical detecting module 14 is disposed inside the accommodating space 18, the base of the optical detecting module 14 is assembled with the base of the accommodating space 18, and the detective portion 141 protrudes from the lateral surface 125. In the embodiments shown in FIG. 4 and FIG. 5, the optical detecting module 14 is disposed on the lateral surface 125 of the housing 12 as a protrusion. The user can experience an operational feel by structural difference between the optical detecting module 14 and the lateral surface 125 when the finger slides over the lateral surface 125, so as to easily determine whether the optical detecting module 14 is actuated accurately.

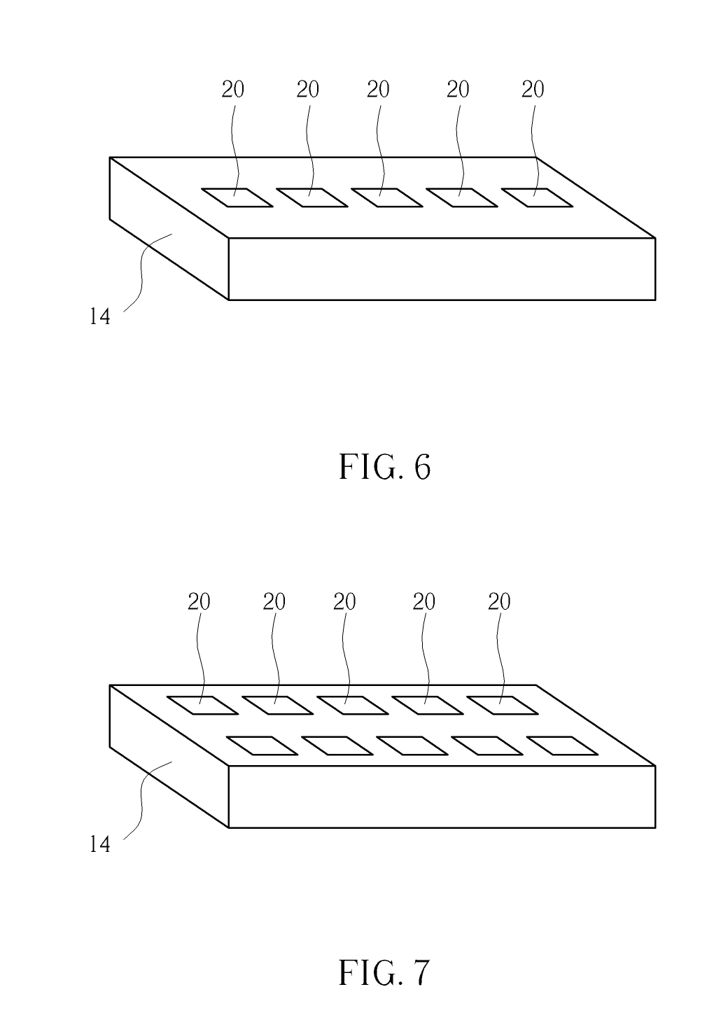

Please refer to FIG. 6 and FIG. 7. FIG. 6 and FIG. 7 respectively are diagrams of the optical detecting module 14 according to different embodiments of the present invention. The optical detecting module 14 can be an array arranged by the plurality of optical finger navigation units 20. As shown in FIG. 6, the plurality of optical finger navigation units 20 forms the array as linear arrangement, the optical detecting module 14 can detect a single-direction movement and a click motion of the touch medium (the user's finger). As shown in FIG. 7, the plurality of optical finger navigation units 20 forms the array as rectangle arrangement, and the optical detecting module 14 can detect the dual-direction movement and the click motion of the touch medium.

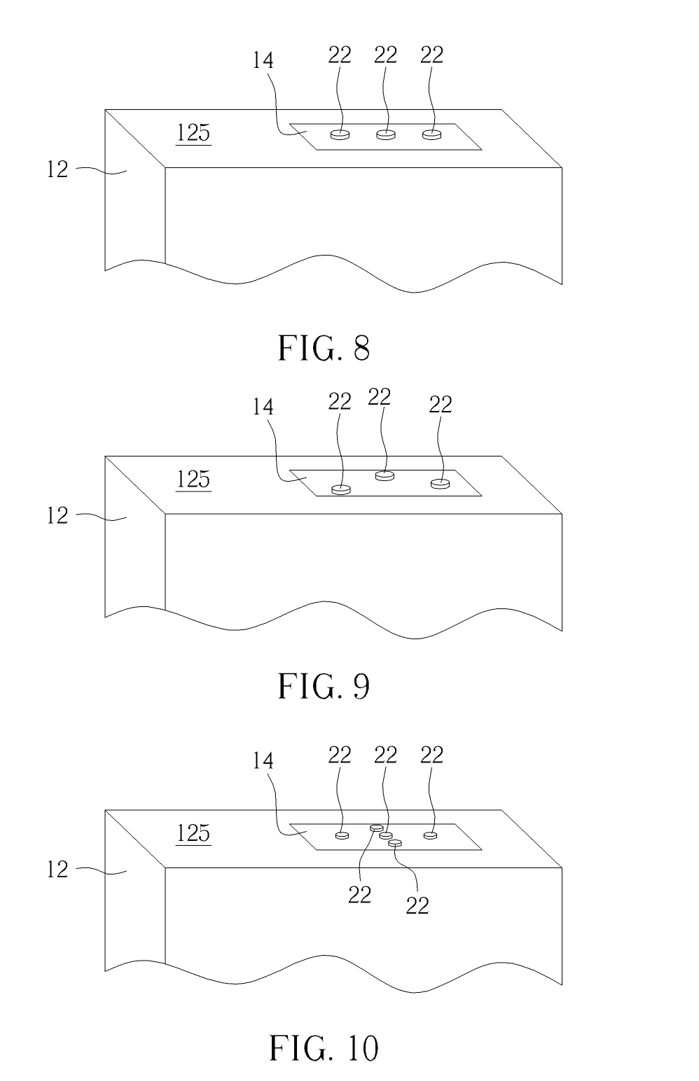

Please refer to FIG. 8 to FIG. 10. FIG. 8 to FIG. 10 respectively are diagrams of the optical detecting module 14 according to different embodiments of the present invention. The optical detecting module 14 can include the plurality of proximity sensors 22 arranged by different forms for multiple dimensional touch operation. As shown in FIG. 8, the plurality of proximity sensors 22 is disposed on the lateral surface 125 of the housing 12 as the linear arrangement, and the optical detecting module 14 detects the single-direction movement and the click motion of the touch medium. As shown in FIG. 9 and FIG. 10, the plurality of proximity sensors 22 is disposed on the lateral surface 125 as triangle arrangement or crisscross arrangement, and the optical detecting module 14 detects the dual-direction movement and the click motion of the touch medium. Arrangement of detective units of the optical detecting module 14 is not limited to the above-mentioned embodiments, and depends on design demand.

As shown in FIG. 1 and FIG. 2, the handheld electronic device 10 can further include a storage unit 24 electrically connected to the control unit 16 for storing a reference value. The optical detecting module 14 can detect user's physiology characteristic, and the control unit 16 can compare the physiology characteristic with the reference value to determine whether the user is an allowable operator, so as to determine whether operational authority of the handheld electronic device is allowed or passed. For example, as the optical detecting signal is the penetrative light and the touch medium has multiple layers with different mediums, the optical reflecting signal is generated by density variation of the multiple layers when the penetrative light passes into the touch medium. The touch medium can be the user's finger, and skin and blood vessel respectively are first medium and second medium of the touch medium. The control unit 16 can obtain contraction variation of the blood vessel according to difference between the optical detecting signal and the optical reflecting signal, the contraction variation can be a wave datum of heartbeat, so that the control unit 16 can verify the user's identification by comparison of the wave datum and the reference value.

Besides, the optical detecting module 14 can scan an exterior contour of the touch medium. The optical reflecting signal can be generated when the optical detecting signal outputted by the optical detecting module 14 projects on surface of the touch medium, and the control unit 16 can obtain a contour datum according to difference between the optical detecting signal and the optical reflecting signal, the contour datum can be the user's fingerprint to compare with the reference value for verifying the identification. Further, the user can draw a specific line over the optical detecting module 14 by the finger, and the optical detecting module 14 can obtain a graph datum according to the movement of the finger. The graph datum can be considered as the handwriting characteristic, and the control unit 16 compares the graph datum with the reference value to verify the identification.

With the consumer's common habit, the housing of the handheld electronic device is put on the palm, and the thumb and the forefinger are respectively located by opposite sides of the housing for stable support. Therefore, the present invention disposes the optical detecting module on the lateral surface of the housing, and the user can easily input the touch command by the thumb or the forefinger when taking the handheld electronic device by one-hand. The present invention provides a convenient operating method better than conventional touch operation that the touch control is executed by moving the finger to the display surface of the handheld electronic device. The handheld electronic device of the present invention can be the portable communication device or the remote controller, such as the mobile phone or the TV controller. The handheld electronic device of the present invention not only disposes the display panel and the input module (keyswitch or touch pad) on the display surface of the housing, but also disposes the optical detecting module on the lateral surface of the housing additionally. Therefore, the present invention has advantages of multiple touch control function and conveniently one-hand operation. Comparing to the prior art, the present invention aims to provide the handheld electronic device with the side-controlling optical detecting module, which conforms to consumer's habit, for increasing market competition of the product.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A handheld electronic device with touch control function, the handheld electronic device comprising:
a housing, the housing comprising a display surface and a back surface opposite to each other, the housing further comprising a top surface, a bottom surface and two lateral surfaces, respectively located between the display surface and the back surface;
at least one optical detecting module disposed on the lateral surface of the housing for detecting a movement of a touch medium; and
a control unit electrically connected to the optical detecting module for outputting a control signal according to the movement of the touch medium.

2. The handheld electronic device of claim 1, wherein the housing further comprises an accommodating space formed on the lateral surface, the optical detecting module is disposed inside the accommodating space, and a thickness of the optical detecting module is substantially smaller than 4 mm.

3. The handheld electronic device of claim 2, wherein a detective portion of the optical detecting module contacts the housing and aligns with the lateral surface in a smoothly continuous manner.

4. The handheld electronic device of claim 2, wherein a base of the accommodating space is a curved structure whereon the optical detecting module is disposed, and a detective portion of the optical detecting module protrudes from the lateral surface.

5. The handheld electronic device of claim 2, wherein a detective portion of the optical detecting module is a curved structure, a base of the optical detecting module is disposed inside the accommodating space, and a detective portion protrudes from the lateral surface.

6. The handheld electronic device of claim 1, wherein the optical detecting module outputs an optical detecting signal and receives an optical reflecting signal generated by the optical detecting signal, the control unit obtains the movement of the touch medium according to intensity variation of the optical reflecting signal.

7. The handheld electronic device of claim 1, wherein the handheld electronic device further comprises two optical detecting modules respectively disposed on the opposite lateral surfaces of the housing.

8. The handheld electronic device of claim 1, wherein the lateral surface comprises an upper area and a low area, the upper area is adjacent to the top surface, the low area is adjacent to the bottom surface, and the optical detecting module is disposed on the upper area of the lateral surface.

9. The handheld electronic device of claim 8, wherein the upper area is adjacent to a sound hole formed on the housing, and the low area is adjacent to a speak hole formed on the housing.

10. The handheld electronic device of claim 1, wherein the optical detecting module is an array arranged by a plurality of optical finger navigation units.

11. The handheld electronic device of claim 10, wherein the plurality of optical finger navigation units forms the array as linear arrangement.

12. The handheld electronic device of claim 10, wherein the plurality of optical finger navigation units forms the array as rectangle arrangement.

13. The handheld electronic device of claim 1, wherein the optical detecting module comprises a plurality of proximity sensors.

14. The handheld electronic device of claim 13, wherein the plurality of proximity sensors is disposed on the lateral surface of the housing as linear arrangement.

15. The handheld electronic device of claim 13, wherein the plurality of proximity sensors is disposed on the lateral surface of the housing as triangle arrangement.

16. The handheld electronic device of claim 13, wherein the plurality of proximity sensors is disposed on the lateral surface of the housing as crisscross arrangement.

17. The handheld electronic device of claim 1, further comprising:
a storage unit electrically connected to the control unit for storing a reference value, the optical detecting module detecting a physiology characteristic, the control unit comparing the physiology characteristic with the reference value to determine whether authority of the handheld electronic device is allowed.

18. The handheld electronic device of claim 17, wherein the optical detecting module outputs an optical detecting signal into a first medium of the touch medium, and receives an optical reflecting signal generated by the optical detecting signal reflected from a second medium of the touch medium, and the control unit obtains a wave datum according to the optical reflecting signal to compare the wave datum with the reference value.

19. The handheld electronic device of claim 17, wherein the optical detecting module outputs an optical detecting signal, and receives an optical reflecting signal generated by the optical detecting signal reflected from a surface of the touch medium, and the control unit obtains a contour datum according to the optical reflecting signal to compare the contour datum with the reference value.

20. The handheld electronic device of claim 17, wherein the control unit obtains a graph datum according to the movement detected by the optical detecting module to compare the graph datum with the reference value.

21. The handheld electronic device of claim 1, wherein the handheld electronic device is a portable communication device or a remote controller.
